(19) United States
(12) Patent Application Publication
(10) Pub. No.: US 2015/0032507 A1
(43) Pub. Date: Jan. 29, 2015

(54) AUTOMATED TARGETING OF INFORMATION TO AN APPLICATION VISITOR BASED ON MERCHANT BUSINESS RULES AND ANALYTICS OF BENEFITS GAINED FROM AUTOMATED TARGETING OF INFORMATION TO THE APPLICATION VISITOR

(71) Applicant: Staples, Inc., Framingham, MA (US)

(72) Inventors: Ashok Narasimhan, Los Altos Hills, CA (US); Amit Rathore, Burlingame, CA (US)

(21) Appl. No.: 14/479,354

(22) Filed: Sep. 7, 2014

Related U.S. Application Data
(63) Continuation-in-part of application No. 12/843,360, filed on Jul. 26, 2010.
(60) Provisional application No. 61/875,001, filed on Sep. 7, 2013.
(60) Provisional application No. 61/875,010, filed on Sep. 7, 2013.
(60) Provisional application No. 61/273,056, filed on Jul. 30, 2009.

(51) Int. Cl. G06Q 30/02; G06Q 30/06

(52) U.S. Cl. CPC G06Q 30/0269; G06Q 30/0633; G06Q 30/0204; G06Q 30/0202
USPC 705/7.31

(57) ABSTRACT

In an example implementation, behavioral data describing past actions including products viewed and purchases made by users while using applications is compiled. The behavioral data is then segmented into clusters of behavior factors according to statistically related actions of the users. Present user data describing a current action of a user while using a merchant application is compiled. A comparative analysis that includes determining a match between the present user data and a cluster from the clusters of behavior factors is performed. A demand function is generated based on the match and the business rules associated with the merchant application. Targeted information is generated based on the comparative analysis. The targeted information includes a discount for the product in the virtual shopping cart. The targeted information including the discount for the product is provided to the user for presentation before the user leaves the merchant application.

### CROSS REFERENCE TO RELATED APPLICATIONS

This application is a continuation-in-part of U.S. patent application Ser. No. 12/843,360, entitled “Automated Targeting of Information to a Website Visitor” and filed Jul. 26, 2010, which claims the benefit under 35 U.S.C. §119(e) of U.S. Provisional Patent Application No. 61/273,056, filed Jul. 30, 2009, the entire contents of each of which are incorporated herein by reference. This application also claims the benefit under 35 U.S.C. §119(e) of U.S. Provisional Patent Application No. 61/875,001, entitled “Automated Targeting of Information to a Website Visitor Based on Merchant Business Rules” and filed Sep. 7, 2013, and U.S. Provisional Patent Application No. 61/875,010, entitled “Analytics of Benefits Gained from Automated Targeting of Information to a Website User” and filed Sep. 7, 2013, the entire contents of each of which are incorporated herein by reference.

### FIELD OF THE DESCRIBED EMBODIMENTS

The described embodiments relate generally to providing information to a potential customer. More particularly, the described embodiments relate, in some cases, to providing automated targeted information to a user while using an application and providing analytics of benefits gained from automated targeting of information.

### BACKGROUND

Online shopping is continually increasing in popularity and has evolved with the growth in technology. Many consumers visit online shopping websites to compare product features and their prices. However, the percentage of online consumers who actually buy a product after viewing it online is very low. An online consumer is mainly influenced by the sales price offered for a particular product. In cases where the sales price offered is appropriate, the online consumer will end up buying the product online.

In order to efficiently use the consumer behavior data, a number of price optimization techniques have been developed. The techniques consider various consumer behavior factors such as time spent on a website, type of products browsed, etc., to provide a consumer with an incentivized pricing scheme. However, most of the price optimization techniques suffer from one or more limitations.

One limitation of existing price optimization techniques is the low conversion ratio of consumers visiting the website to consumers making an online purchase through the website. Further, another limitation of the existing price optimization techniques is to monitor consumer behavior on a large scale across a large number of websites and merchant types. Monitoring consumer behavior on a large scale requires deployment of an extensive hardware and software infrastructure.

There is a need for a method, and a system for optimizing information provided to different consumers based on the stage of the product purchase cycle a consumer is in. Further, there exists a need for providing an optimum pricing mechanism for a merchant that is based on present consumer behavior and predetermined past customer behavior.

### SUMMARY

According to one innovative aspect of the subject matter described in this disclosure, a system includes one or more processors and one or more memories storing instructions that, when executed by the one or more processors, cause the system to, compile with a server coupled to a computer network behavioral data describing past actions including products viewed and purchases made by users while using applications hosted by servers accessible by computers of the users via the computer network; segment with the server the behavioral data into clusters of behavior factors according to statistically related actions of the users; compile with the server present user data describing a current action of a user while using a merchant application hosted by the server coupled to the computer network and accessible by the user, the current action including the user adding a product to a virtual shopping cart of the merchant application; while the user is still using the merchant application, perform with the server a comparative analysis including determining a match between the present user data and a cluster from the clusters of behavior factors and generating a demand function based on the match and the business rules associated with the merchant application; generate with the server targeted information based on the comparative analysis, the targeted information including a discount for the product in the virtual shopping cart; and provide by the server the targeted information including the discount for the product to the computer of the user for presentation before the user leaves the merchant application.

In general, another innovative aspect of the subject matter described in this disclosure may be embodied in methods that include compiling with a server coupled to a computer network behavioral data describing past actions including products viewed and purchases made by users while using applications hosted by servers accessible by computers of the users via the computer network; segmenting with the server the behavioral data into clusters of behavior factors according to statistically related actions of the users; compiling with the server present user data describing a current action of a user while using a merchant application hosted by the server coupled to the computer network and accessible by the user, the current action including the user adding a product to a virtual shopping cart of the merchant application; while the user is still using the merchant application, performing with the server a comparative analysis including determining a match between the present user data and a cluster from the clusters of behavior factors and generating a demand function based on the match and the business rules associated with the merchant application; generating with the server targeted information based on the comparative analysis, the targeted information including a discount for the product in the virtual shopping cart; and providing by the server the targeted information including the discount for the product to the computer of the user for presentation before the user leaves the merchant application.

Other implementations of one or more of these aspects include corresponding systems, apparatus, and computer programs, configured to perform the actions of the methods, encoded on computer storage devices.

These and other implementations may each optionally include one or more of the following features such as that the present user data includes a second current action by the user adding one or more additional products to the virtual shopping cart; that generating the targeted information that includes the discount for the product in the virtual shopping cart further includes determining a coupon for the products in the virtual shopping cart based on the business rules associated with the merchant application; that providing the targeted information includes providing the coupon for application to a total price of the product and the one or more additional products included in the virtual shopping cart; that the business rules include one or more of a product group rule, a price group rule, and a product category group rule; receiving wish list data describing one or more products saved by the user for a future purchase using corresponding interface elements of the merchant application; storing the wish list data in a non-transitory storage device in association with the user; querying the wish list data and a product database to determine one or more corresponding products to the one or more products in the wish list data; that generating the targeted information further includes generating a recommendation for the one or more corresponding products and including the recommendation in the targeted information; receiving by the server via the computer network a minimum advertised price (MAP) contract as one or more of the business rules, the MAP contract being between a merchant of the merchant application and a manufacturer of products offered for sale via the merchant application; determining with the server a time and location for displaying the discount price to the user on the merchant application based on the MAP contract; determining with the server a current time and location in association with the user's use of the merchant application; determining a match between the current time and location and the time and location of the MAP contract; calculating the discount price for the product based on the match; receiving from a computing device associated with a merchant of the merchant application, custom computer language including business terms and business logic expressing the business rules for the merchant application; storing the custom computer language as the business rules in a non-transitory storage device coupled to the server; receiving with the server via the computer network sales velocity data describing sales velocity associated with the product; that the demand function is further generated based on the sales velocity and a corresponding sales velocity business rule stipulated by a merchant associated with the merchant application; and that the corresponding sales velocity business rule varies the discount applicable to the product based on whether the sales velocity is low or high.

In general, yet another innovative aspect of the subject matter described in this disclosure may be embodied in methods that include receiving business rules for an application hosted by the server coupled to a computer network and accessible by users; compiling with the server present user data describing a current action of a user while using the application hosted by the server; while the user is still using the application, computing with the server a match between the present user data and a precompiled cluster of behavior factors; responsive to computing the match, generating with the server based on the match targeted information that includes information influenced based on business rules associated with the application; and transmitting the targeted information to a computer of the user for presentation prior to the user leaving the application.

These and other implementations may each optionally include one or more of the following features, such as that the business rules include one or more of a product group rule, a price group rule, and a product category group rule; that generating the targeted information further includes: receiving by the server via the computer network a merchant determined rule including a range of business terms and conditional logic; that applying by the server the business terms and conditional logic in combination to the targeted information; influencing by the server via the computer network the targeted information based on a user specific list; that the user specific list is a user wish list that includes one or more products desired by the user; receiving by the server data describing a current action of a user while using the application; the current action including the user adding a product to a virtual shopping cart of the merchant application; that the targeted information includes a discount price for the product; receiving by the server via the computer network a minimum advertised price (MAP) contract as one or more of the business rules; that the MAP contract being between an administrator of the application and a manufacturer of products offered for sale via the application; determining with the server a time and location for displaying the discount price to the user on the application based on the MAP contract; determining with the server a current time and location in association with the user's use of the merchant application; determining a match between the current time and location and the time and location of the MAP contract; calculating the discount price for the product based on the match; receiving with the server via the computer network sales velocity data describing sales velocity associated with the product; influencing by the server via the computer network the targeted information based on the sales velocity; estimating with the server real-time revenue increases and money earned by the application based on presenting the targeted information to the user; generating with the server a report showing sales data of the application while providing the targeted information to the user; and that the report includes product comparisons between one or more additional competitive merchants.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 shows an example of system for collecting and analyzing behavioral data of a plurality of users from a plurality of applications (e.g., websites).

FIG. 2 shows an example of system for matching the present user data with at least one of the different clusters of behavior factors, and while the present user is still visiting the present application (e.g., website), generating and displaying targeted information to the present user.

FIG. 3 is a flow chart that includes an example method of targeting information to a user while using an application.

FIG. 4 is a flow chart that includes steps of a method of providing real-time targeted information to a consumer.

FIG. 5 is a flow chart that includes an example method of providing real-time targeted economic value information to a consumer.

FIG. 6 shows a computing architecture in which the described embodiments can be implemented.

### DETAILED DESCRIPTION

The embodiments described include methods and apparatuses for providing automated, real-time information targeted to a website visitor. In some embodiments, this includes providing price discounts in real time based on consumer characteristics to increase the conversion ratio of online consumers visiting a merchant's application to online consumers making a purchase on the application.

Typically, online consumers leave a merchant's application after viewing the product details page. Some consumers may add a product to their shopping cart, but later discontinue the purchase of the product in the shopping cart. However, a consumer who has added a product to the shopping cart is more likely to purchase the product than the consumer who has simply viewed the product details page. Such consumer behavioral data of those who added a product to their shopping cart, if collected, can be used for various purposes such as setting the sale price or offering discounts on the sale price of a product.

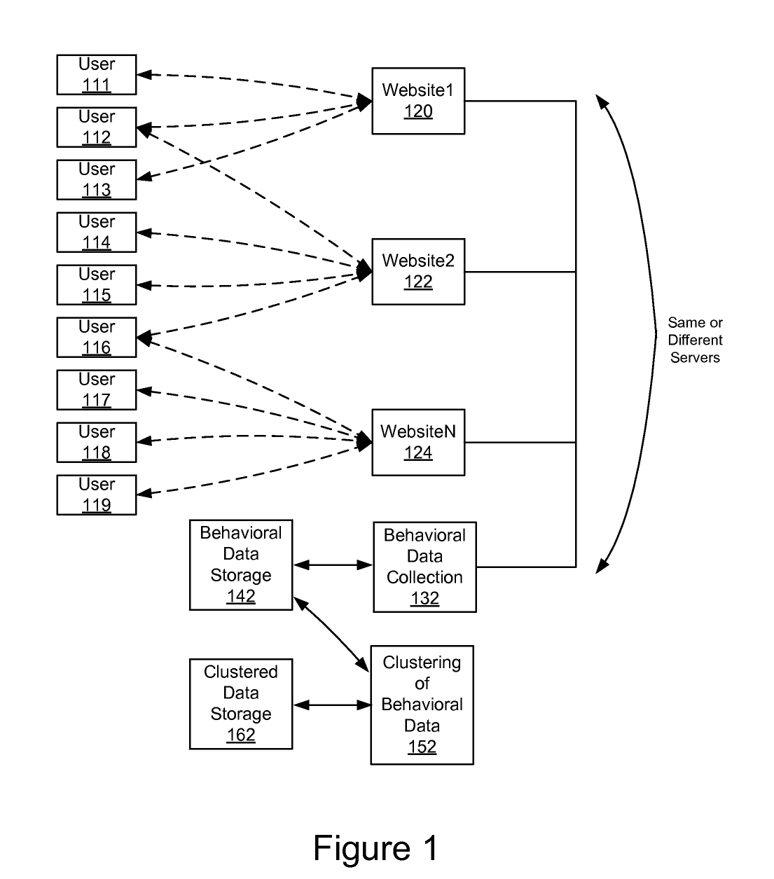

FIG. 1 shows an example of system for collecting and analyzing behavioral data of users from a plurality of applications, such as websites, although other variations are possible where an application's acts, structure, and/or functionality is distributed between an application operating natively on a user's computer and an application hosted by a server coupled to a computer network. As shown, exemplary users 111-119 visit websites 120, 122, 124. The actions of the users 111-119 as they visit the websites 120, 122, 124 can be monitored and collected. More specifically, behavioral data of the users 111-119 can be collected from the websites 120, 122, 124 by monitoring the websites 120, 122, 124 and collecting the data about the users. The users 111-119 include computing devices coupled to a computer network, to which the websites 120, 122, and 124 and server 132 and 152 are also coupled. The network may include any computer network across which computing devices may communicate and interact, such as public and private networks, virtual networks, etc.

As shown, a server 132 collects the behavior data which is then stored (storage 142).

The storage 142 or storage 162 may be a non-transitory storage device that stores data. For example, the storage 142 or storage 162 may include a dynamic random access memory (DRAM) device, a static random access memory (SRAM) device, flash memory, and/or some other memory device. In some implementations, the storage 142 or storage 162 includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, and/or some other non-volatile storage device.

In some embodiments, the collected data may include actions of the visiting users before arriving at the merchant application, actions taken on the merchant application such as which pages were viewed in what order, products placed into a shopping cart, purchases subsequently made by the visiting users, etc. For instance, the collected behavior data includes past actions including products viewed and purchases made by users while using applications. The collected data can include, for example, pre-click information, checkout status, and/or post-click information. A non-exhaustive exemplary list of pre-click information includes a referral URL (Universal Resource Locator), search (such as, search, number of search terms, specific search terms, specific search phrases), banner advertisements (such as, advertisement context, referrer domain, second referrer domain), comparison engine (such as, number of search terms, specific search terms, specific search phrases, comparison page context, customer entered zip code), referrer domain, referrer page contents (such as, shopping comparison site), customer information (such as, return customer, characterizing history data), customer location (such as, time zone, location, demographics, weather, merchant shipping costs). A non-exhaustive exemplary list of check out status includes adding to cart, viewing cart, and/or checkout. A non-exhaustive exemplary list of post-click information includes path/actions through site, products viewed, browsing pattern, time on site, cart contents (such as, products, product groups, value, abandonment), current location in funnel, day of week, special day and/or price modifications already applied.

In some embodiments, the collected data may include present user data, which is data collected in real-time (e.g., contemporaneously with a user's use of an application, such as a website, etc.) describing a current action of a user while using a merchant application, the current action includes the user adding a product to a virtual shopping cart of the merchant application. For instance, the present user data may include one or more user actions reflecting a user's behavior in interacting with the application.

A server 152 analyzes the collected behavior data. The analyzing can include clustering the collected behavioral data, which in some embodiments, includes segmenting the collected behavioral data into clusters of behavior factors according to statistically related actions of the users. The segmented behavior factors can be used to predict future behavior of the users. The clustered collected behavioral data can be stored in clustered data storage 162 for future access.

For example, the collected behavioral data may indicate, through statistical analysis, that visiting users who view certain pages of a website, such as those describing a tennis racket, are more likely to purchase certain products (such as tennis balls) if offered at a certain discount, than those who do not view those pages.

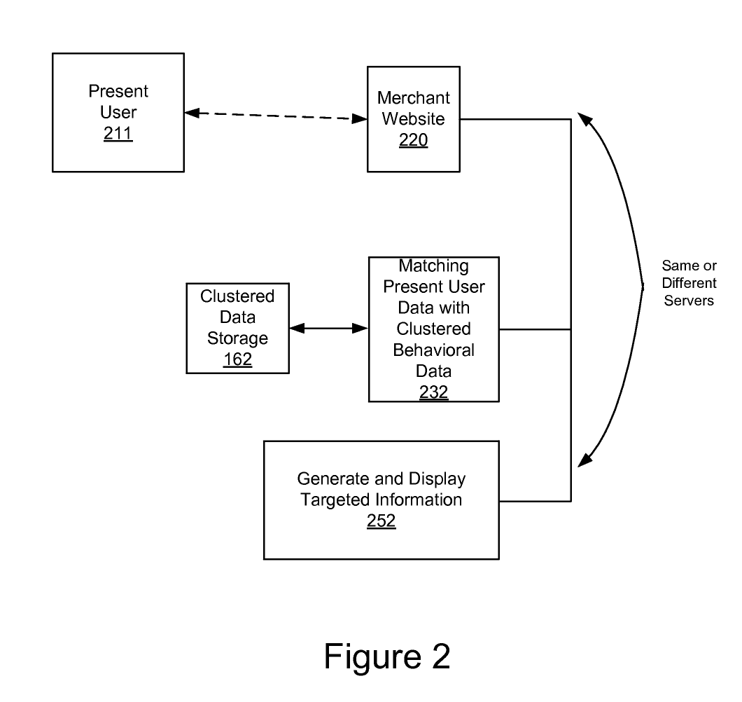

FIG. 2 shows an example system for matching the present user data with at least one of the clusters of behavior factors, and while the present user is still visiting the present application (e.g., website), generating and displaying targeted information to the present user. A present user 211 accesses a merchant website 220. A server 232 executes a matching of the present user data with at least one of the clusters of behavior factors.

It should be understood that the servers 132, 152, 232, and 252, and the servers hosting the websites 120, 122, 124, and 220, as shown and described, may be the same server, the same group of servers, common/shared servers, distinct servers (coupled via a network for communication), a combination of the foregoing, etc. Moreover, the use of the term server is not limited to a single virtual, software, and/or hardware server but may include two or more such servers depending on the embodiment.

In some embodiments, the matching is based on a comparative analysis of the present user data with the clustered behavior factors of the clustered database stored in the storage 162. In some embodiments, the comparative analysis includes identifying correlations between the present user data and each of the clustered behavior factors, and identifying which of the clustered behavior factor is most correlated to the present user data, thereby identifying a match between the present user data and the at least one cluster of behavior factors. In a non-limiting example, a match includes using one of the clusters of behavior factors from the collected behavioral data of the users that have used the merchant application previously and using one of the clusters of behavior factors for finding a corresponding relationship to the present user data of the user while using the merchant application. For example, the behavioral data collected from the users may include content reviewed by the users across many applications. The content reviewed may include but is not limited to, a car blog on the merchant application and/or search terms such as (Ford, V8 engine, tires, etc.) entered by the users. In some embodiments, the collected behavioral data is segmented by the server 152 into clusters of behavior factors that contain similar behaviors (pages browsed, search terms, etc.) of the users. In some embodiments, the present user data may include similar pages browsed, search terms entered (American cars, V8 engine, summer tires, etc.) and blogs visited on the merchant application. Using the present user data and one of the clusters of behavior factors the server 232 computes the match by comparing the present user data with one of the clusters of behavior factors collected and upon a successful correlation, the server 252 will provide targeted information (ads, recommended products, etc.) to the present user. Numerous other variations are also possible and contemplated.

Some embodiments include the present user loading pages from the application that describe tennis rackets. Contemporaneous to the load, the server 232 collects data describing the pages being loaded on the application and matches one or more characteristics of the pages (products included in the pages), to one or more clusters of behavior factors in the clustered behavioral data of server 232 and clustered database stored in the storage 162. In some embodiments, the stored clustered behavioral data may include clusters that describe the present user as a certain shopper such as one that purchases products associated with a specific category (e.g. gardening, sports, home appliances, furniture) and/or purchases products (e.g., tennis balls) that are discounted.

In some embodiments, for example, the match may include identifying with the server 232 a corresponding relationship between the products browsed by the user on the pages and one of the clusters of behavior factors associated with the user, which in return may include identifying the present user as likely to purchase the product (e.g., tennis balls) if offered at a certain discount. The process of matching data occurs in an elapsed time short enough such that actions subsequently motivated by the match can be made without the present user being aware that such time has elapsed and before the present user can perform another action, such as leaving the application (e.g., merchant website).

Existing methods of matching user data to behavioral segments cannot effect the match in a manner timely enough not to be noticed by users or to allow the system to take actions to affect user behavior before the user takes actions that preclude it, such as leaving the application.

A server 252 provides targeted information (e.g., a price discount for an in-cart product) based upon the matching.

For example, the completed match for present users who view pages describing tennis rackets may indicate that these users should be offered a discount on tennis balls, and further, that such discount should be of a particular size (amount) to optimize the overall profit gained by the merchant.

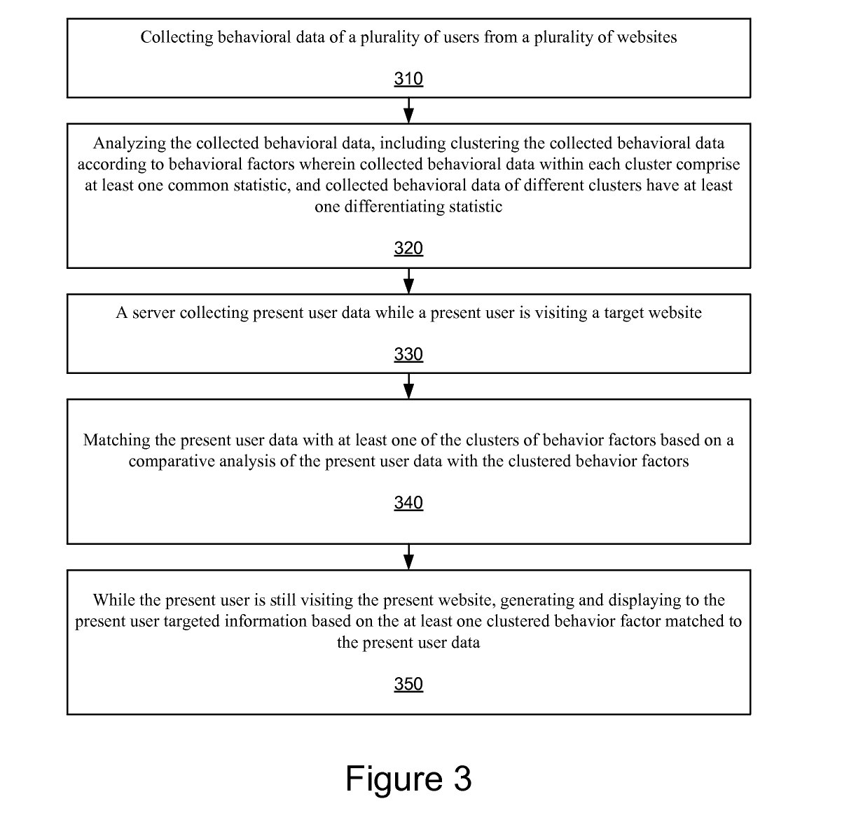

FIG. 3 is a flow chart that includes steps of an example method of targeting information to a user while using an application. A first step 310 includes collecting behavioral data of users from a plurality of applications. A second step 320 includes analyzing the collected behavioral data, including clustering the collected behavioral data according to behavioral factors. The collected behavioral data within each cluster may include at least one common statistic, and collected behavioral data of different clusters have at least one differentiating statistic. A non-limiting example of a common statistic within each cluster may include products of the same manufacture and a category browsed by users while using the application, while a differentiating statistic within each cluster may include products of the same category (tires, etc.) but different manufactures (Michelin, Bridgestone, Toyo, etc.). A third step 330 includes a server 232 collecting present user data while a present user is visiting a target application (e.g., website, native app, etc.). A fourth step 340 includes the server 232 matching the present user data with at least one of the clusters of behavior factors based on a comparative analysis of the present user data with the clustered behavior factors. A fifth step 350 includes while the present user is still visiting the present application, generating and displaying to the present user targeted information (via the server 252 and/or the computer of the present user) based on the at least one clustered behavior factor matched to the present user data.

### Analytics

Some embodiments further include utilizing analytic models to estimate in real-time revenue increases and money earned by the merchant via the merchant application when presenting the targeted information to the user. In some embodiments, the estimates are performed real-time, and performed over a measurement period. For instance, the measured period can conform to business time periods—say monthly (calendar months) or by financial quarters.

Some embodiments further include generating with the server 252 a report showing merchant sales data while providing the targeted information to the user. For example, the report may include that merchant sales data increases while providing the targeted information. Some embodiments further include showing comparisons between different merchants, thereby providing incentive for other merchants to utilize the method of targeting information. For instance, in a marketplace scenario, this could show the benefit derived by the top 20 sellers, by increased revenue, increased profit, or increased conversion rates, etc.

Some embodiments further include utilizing statistical measurements of the impact of the targeted information, and further providing for selective inclusion and exclusion of users or products, thereby providing a presentation of the impact of the targeted information on the included or excluded user or product. This allows product and shopper exclusions to be specified by the merchant as needed, without impacting the statistical validity of the measurement, while also providing a detailed measurement of the excluded portion of the business. For instance, using an administrator's interface and viewing the statistical measurements, the merchant can update one or more business rules based on the statistical measurements, such as expressly include/exclude certain user types and/or products from certain promotions. The server 232 may receive and store the business rules in the storage 142, 162, or another storage device for later use during generation of targeted information. In some embodiments, the server 232 may be configured to automatically update one or more business rules based on the statistical measurements, which are later used to expressly include and/or exclude certain users and/or products when corresponding targeted information is being generated.

### Embodiments of the Targeted Information Based on Merchant Business Rules

Some embodiments include influencing information included within the targeted information based on business rules. In some embodiments, the business rules are static, and applied to dynamic data. Examples of business rules include one or more of a product group rule, a price group rule, and a product category group rule. This is a non-exhaustive list, and can include groups based on other attributes of products such as weight, dimensions, color, brands, descriptions, user reviews, etc. In some embodiments, the dynamic data includes a catalog data, an inventory data, a best-selling and worst selling ranking, etc.

### Wish-List Promos

Some embodiments further include influencing the information within the targeted information based on a user specific list. For example, the user specific list is a user wish list describing one or more products saved by the user for a future purchase using corresponding interface elements of the merchant application. In an embodiment, the wish list can be stored on a non-transitory storage device that is associated with the user, such as the storage 142 or 162. Furthermore, the wish list may be used to determine one or more corresponding products offered by the merchant application to the one or more products in the wish list. In an embodiment, the influenced targeted information can include information including a recommendation for the one or more corresponding products. For example, if the wish list includes a camera that the user desires, the recommendation in the influenced targeted information may include products that are related to the camera including memory cards, lenses, wireless file transmitters, photo printers, etc.

### Minimum Advertised Price (MAP) Promo

In some embodiments, the server 252 may influence the targeted information based on a minimum advertised price (MAP) contract. In some embodiments, the MAP contract reflects one or more of the business rules. In some embodiments, the targeted information includes at least a price determined based on the MAP contract that is displayed to the user via the merchant application. For example, the MAP contract can be explicitly between a merchant of the merchant application and a manufacturer of the products offered for sale via the merchant application. In some embodiment, a time and location for displaying the discount price to the user on the merchant application is determined based on the MAP contract. For instance, the MAP contract may stipulate that the discount price be displayed to the user only in the shopping cart at checkout, in which case the targeted information will be displayed to the user only when the user initiates the checkout process. In another example, the MAP contract may stipulate a product price to be discounted, or discount levels for certain user types, etc., and the server 252 may determine the targeted information (e.g., the price discount) based on these price parameters stipulated by the MAP contract. In some embodiment, the MAP contract may specify time and/or location for when certain discounts/prices may apply. For instance, the server 232 may determine a current time and location in association with the user's use of the merchant application which it may then use for determining a match between the current time and location associated with the user's use of the merchant application and the time and location associated with a product in the MAP contract. If the time and location discount is applicable based on the match, the server 252 may calculate the appropriate product discount based thereon.

### Sales Velocity

Some embodiments further include influencing information within the targeted information based on sales velocity data, which describes the sales velocity(ies) associated with one or more products. For instance, if the sales velocity of a given product is high (e.g., a lot of people are buying the product during a certain timeframe), the merchant may stipulate a lower overall discounting strategy. On the other hand, when the sales velocity of the product is low (few people are buying the product during a certain timeframe), the merchant may stipulate a more aggressive discounting strategy. In an embodiment, the server 252 influences what products are included within the targeted information based on the sales velocities for those products. The server 252 may also influence the price (e.g., determine that the prices should be lower or higher) of the products included within the targeted information based on the sales velocities associated with those products.

In some embodiments, the server 252 may be configured to generate a demand function based on the business rules associated with the merchant application. For instance, the server 252 may generate the demand function based on the sales velocity and a corresponding sales velocity business rule stipulated by a merchant associated with the merchant application. In an embodiment, the sales velocity business rules vary the discount that is applicable to a given product based on whether the sales velocity is high or low.

### Dynamic Discount

In some embodiments, the targeted information includes multiple discounts for multiple products, and the server 252 may compute a single cart-level discount based on the multiple coupons. This is particularly useful when a merchant ecommerce platform (a website including a cart server) does not have a mechanism to apply more than a single cart-wide discount coupon. This mechanism then overcomes this constraint by dynamically computing and then issuing an average discount value coupon based on the individual (and different) discounts given to different products in the cart. This allows different products to be treated differently, e.g., based on margin differences, even if the cart doesn't support multiple coupons.

In some embodiments, the webpage may include executable code (e.g., a JavaScript module) executable by the computer of the customer to communicate with the server 252 to receive the targeted information (e.g., the cart-level discount) and apply it to the virtual shopping cart displayed to the user in association with the webpage.

In some embodiments, the dynamic discount available to the user is based on business rules relating the current actions of the user. For instance, as the user adds an item to a virtual shopping cart, the application may transmit data reflecting this action (e.g., asynchronously) to the server 232, which may receive it and provided it to the server 252 to use it to determine whether to discount a price. In some instances, the present user data may include how long the item has been in the cart (thereby indicating that the user is hesitating to purchase the item and may be considering abandoning the purchase). Based on this, the server 252 may compute a discount based on information known about the user and business rules associated with the application and provide it to the application for presentation to the user before the user quits the application.

In some embodiments, the server 252 is configured to generate targeted information that includes the discount for the product in the virtual shopping cart. In some embodiments, the discount is in a form of a coupon for the products in the virtual shopping cart which is determined based on the business rules associated with the merchant application. In some embodiments, the server 252 may generate a coupon for the product(s) in a virtual shopping cart based on the business rules associated with the merchant application. The coupon may be generated for an initial product added to the virtual shopping cart and/or for additional products added to the virtual shopping cart. For example, the present user data may include a second current action performed by the user, which reflects that the user has added one or more additional products to the virtual shopping cart. The server 252 may then generate a coupon and include it in the targeted information provided to the computer of a user for application to a total price of the product and the one or more additional products included in the virtual shopping cart.

### Rapunzel—Rule Setting by Merchants

In some embodiments, information within the targeted information is influenced by merchant determined rules. The merchant determined rules can include one or more of the business rules. In some embodiments, a merchant can expresses the business rules for the merchant application based on using custom computer language including business terms and business logic. For instance, the custom computer language allows the merchant to dynamically and instantly implement the merchant determined rules. As a further example, the merchant, using an applicable computer interface, may input the business rules and instruct the computer to transmit them to the server 232 for storage and/or use thereby. The server 232 may accordingly store the business rules (e.g., the custom computer language) in a non-transitory storage device, such as storage 142 or 162.

In some embodiments, collecting behavioral data of users from a plurality of applications includes monitoring merchant applications and collecting data about users that visit the merchant application. For example, the applications used by the users may monitor user actions while using various applications (e.g., websites, native apps, etc.) associated with various merchants or other service providers and transmit that data to the server 152 for collection, storage, and clustering thereby. The user actions may, in some examples, reflect products viewed and purchases made by users while using the applications. By way of further example, the collected data includes actions of the visiting users before arriving at the merchant application, actions taken on the merchant application such as which pages were viewed in what order and any products placed into a virtual shopping cart and purchases subsequently made by the visiting users.

In some embodiments, clustering the collected behavioral data includes segmenting the collected behavioral data into behavior factors according to statistically related actions of the users, where the segmented behavior factors can be used to predict future behavior of the users.

In some embodiments, compiling behavioral data of a user while using a merchant application includes, monitoring the merchant application and compiling present user data describing a current action of the user while using the merchant application. For example, the current action includes the user adding a product to a virtual shopping cart of the merchant application.

In some embodiments, while the user is still using the merchant application, includes performing a comparative analysis including determining a match between the present user data and a cluster from the clusters of behavior factors and generating a demand function based on the match and the business rules associated with the merchant application.

In some embodiments, the comparative analysis includes determining a match between the present user data and a cluster from the clusters of behavior factors and generating a demand function based on the match and the business rules associated with the merchant application.

For example, in some embodiments, the comparative analysis of the present user data with the clustered behavior factors includes identifying correlations between the present user data and each of the clustered behavior factors, and identifying which of the clustered behavior factor is most correlated to the present user data, thereby identifying a match between the present user data and the at least one cluster of behavior factors. The identified correlation can include, for example, at least one of timing of user actions, and history of the user. The timing of user actions can include, for example, at least one of timing of elapsed time between the user's appearance on the present application and first carting, or timing between visits by the user to the present application. The history of the user can include at least one of information of whether the user was directed to the present application through a search service, whether the user was directed to the present application through a comparison shopping service, the user's order of pages browsed, search terms used by the user to arrive at the present application, attributes of a referring application.

In some embodiments, the identified correlations include at least one of a computer type (for example, Macintosh® versus PC) of the user, an operating system type (such as, Windows® versus Unix) of the user, a browser type of the user (for example, Explorer® versus Netscape), or a location (for example, latitude and longitude) of the user.

In some embodiments, the match is between the present user data and a precompiled cluster of behavior factors. In some embodiments, generating targeted information based on the comparative analysis includes a discount for the product in the virtual shopping cart. In some embodiments, the targeted information including the discount for the product in the virtual shopping cart is provided to the user before the user leaves the merchant application. This particular point in the user's application visit can be a particularly opportune time to offer, for example, the discount that will prompt a transaction to actually occur.

In some embodiments, the targeted information is additionally based on product information of competitive merchant products. The product information can be obtained, for example, by determining past search terms used by the present user, running a real-time search during the present user's session, determining competitive merchants based on search results of the real-time search. By analyzing the prices offered by the competitors, a comparative analysis of the prices offered by all the players, including the competitors and the merchant can be performed. Typically, a consumer is directed to a merchant's webpage through a search engine. The search terms are included in the referral URL, which has directed the consumer to the merchant's webpage. Search terms used by the consumer can be identified based on the URL parameters in the merchant's webpage passed on by the search engine. Those search terms can be entered at the search application to download the search results page, and store the results for an offline analysis.

During an offline analysis, pricing of similar products offered by competitors, which have been provided by the search engine, are identified. Competitor data can be aggregated in search results such as the price data of the competitor products, or merchant data listed in the search results page. The competitor data is related with the consumer's behavior on the merchant's application. A “quality score” for the search results page produced can be calculated from search terms. The quality score is determined by ascertaining a Click Through Rate (CTR) of a user on the merchant's application among the search results. CTR is obtained by dividing the number of users who clicked on a link by the number of times the link was delivered. A server can then provide feedback to the merchant on the performance of activities in search engine optimization and Search Engine Marketing (SEM) such as buying keywords from SEM vendors such as Google® AdWords, Yahoo!® Search Marketing and Microsoft® adCenter. Search engine optimization is a process of enhancing the volume of web-traffic from a search engine to a merchant's site. Competitors' product prices can be compared to the merchant's product prices. This analytic data can be provided to the merchant for price optimization.

Some embodiments include collecting (obtaining) additional information of a customer by using a JavaScript program on the merchant application. The JavaScript program in real time identifies the consumer based on the cookies in the consumer's browser, and the program stores a real-time feed of the consumer's behavior.

First-party cookies can be dropped by the merchant's website onto the consumer's browser, which may be used for tracking the consumer across all of the merchants serviced by the automated price optimization service. When a consumer visits a merchant's application, the JavaScript program opens a first IFrame within the merchant's webpage. The first IFrame corresponds to a web page hosted on a server. The first IFrame searches for a first-party cookie belonging to the server and including identification information of a consumer. If the consumer is new and no earlier first-party cookie is identified, a new first-party cookie is dropped on the consumer's browser. The first IFrame then launches a second hidden IFrame hosted on the merchant's server. The consumer identification information is passed on to the second IFrame as parameters within the Uniform Resource Locator (URL) of the second hidden IFrame. The second hidden IFrame then stores the consumer identification information in a new or existing first-party cookie corresponding to the merchant's application. Thereafter, the consumer identification information is passed from a cookie corresponding to a cookie corresponding to any other merchants' application. Therefore, the consumer is tracked on any merchant's application, even if the consumer has disabled or blocked third-party cookies on his/her browser.

The JavaScript program also gathers consumer behavioral information, such as shopping data before purchase and after purchase, prices offered, and purchase history, and stores it in database for an offline analysis. Consumers are identified by using cookies on their browsers. The JavaScript program runs on the web pages of all the merchants. This helps in gathering consumer behavioral information from multiple merchants' applications.

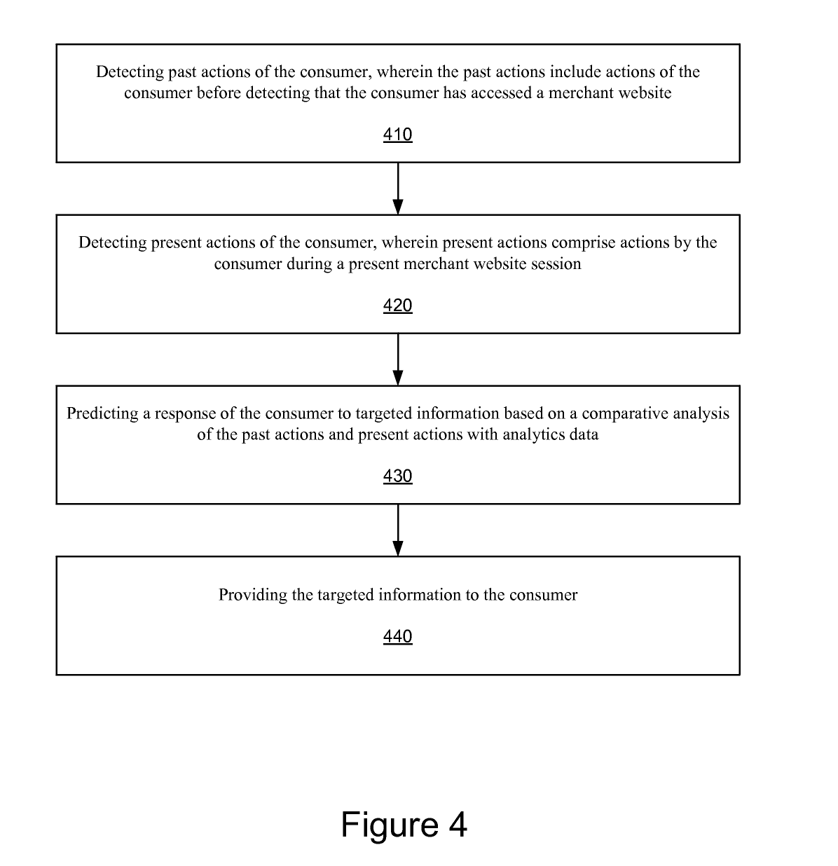

FIG. 4 is a flow chart that includes steps of a method of providing real-time targeted information to a consumer. A first step 410 includes detecting past actions of the consumer, where the past actions include actions of the consumer before detecting that the consumer has accessed a merchant application. A second step 420 includes detecting present actions of the consumer, where present actions include actions by the consumer during a present merchant application session. A third step 430 includes predicting a response of the consumer to targeted information based on a comparative analysis of the past actions and present actions with analytics data. A fourth step 440 includes providing the targeted information to the consumer.

In some embodiments, the analytic data is collected and analyzed. For example, as previously described, this can include collecting behavioral data of a plurality of users from a plurality of applications. The collected behavioral data is analyzed by clustering the collected behavioral data according to behavioral factors where collected behavioral data within each cluster comprise at least one common statistic, and collected behavioral data of different clusters have at least one differentiating statistic.

As previously mentioned, the providing of the targeted information to the consumer can be conditioned upon a determination that the consumer is attempting to leave the merchant application. In some embodiments, providing the targeted information to the consumer includes embedding and integrating the targeted information into the merchant's application.

As previously described, detecting past actions of the consumer can include determining past search terms used by the consumer, running a real-time search during the consumers present session, and determining competitive merchants based on search results of the real-time search. This can further include analyzing product information of the competitive merchants, and generating targeted information based on the analyzed product information.

In some embodiments, the comparative analysis includes generating a demand function for the consumer, where the demand function includes consumer characteristics, predetermined merchant rules, competitive information, and/or product type. Prices presented on the merchant's application can be managed based on the demand function. The demand function can be adaptively updated.

For example, a present user that views pages describing tennis rackets may be willing to purchase tennis balls at a price different from other users who had not viewed such pages. The demand function describes such willingness to buy products, at various prices, depending on the segment or factor a given user was matched to in the Consumer Behavioral Data.

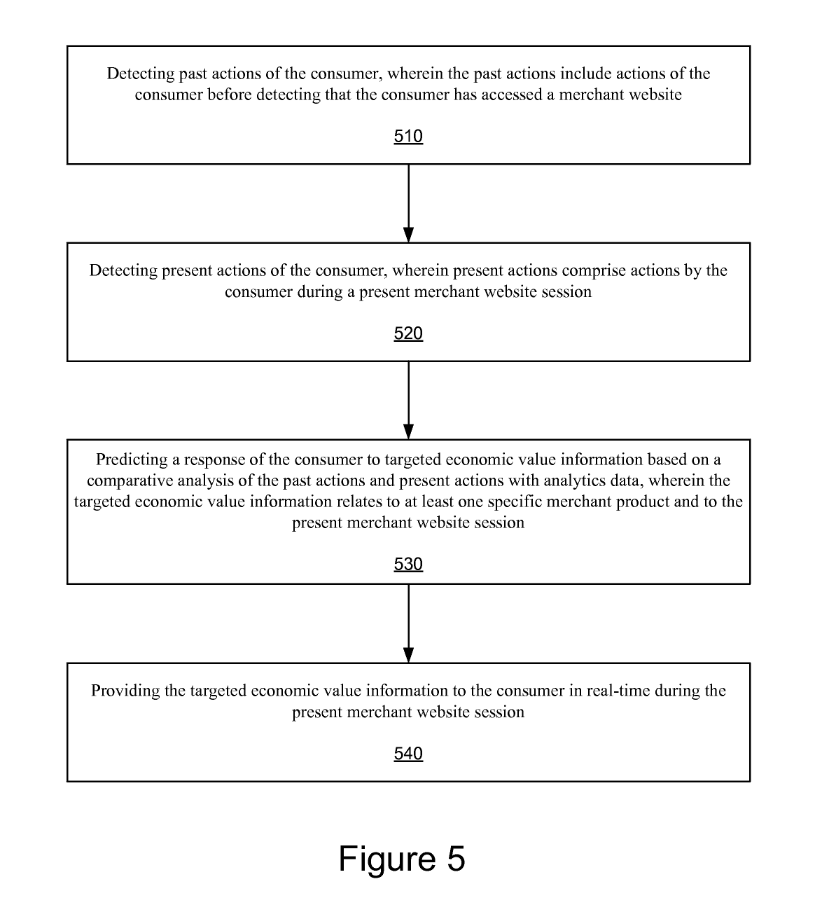

FIG. 5 is a flow chart that includes the steps of an example of a method of providing real-time targeted economic value information to a consumer. A first step 510 includes detecting past actions of the consumer, where the past actions include actions of the consumer before detecting that the consumer has accessed a merchant application. A second step 520 includes detecting present actions of the consumer, where present actions comprise actions by the consumer during a present merchant application session. A third step 530 includes predicting a response of the consumer to targeted economic value information based on a comparative analysis of the past actions and present actions with analytics data, where the targeted economic value information relates to at least one specific merchant product and to the present merchant application session. A fourth step 540 includes providing the targeted economic value information to the consumer in real-time during the present merchant application session.

In some embodiments, the targeted economic value information includes a specific offer of a price for a specific product. However, in some embodiments, the targeted economic value information includes things other than price. For example, an offer of free shipping or a two-for-one offer can additionally or alternatively be provided as examples of targeted economic value information. The targeted economic value information can be provided to the consumer in real-time during the present merchant application session. That is, the information is generated and displayed fast enough that the consumer visiting the merchant's application perceives the displayed information as “real-time.” That is, the consumer cannot observe a noticeable delay. The information is provided while the consumer is still on the merchant's application, and can be triggered, for example, by the consumer exiting a merchant application shopping cart, or attempting to leave the merchant's application without a purchase being completed.

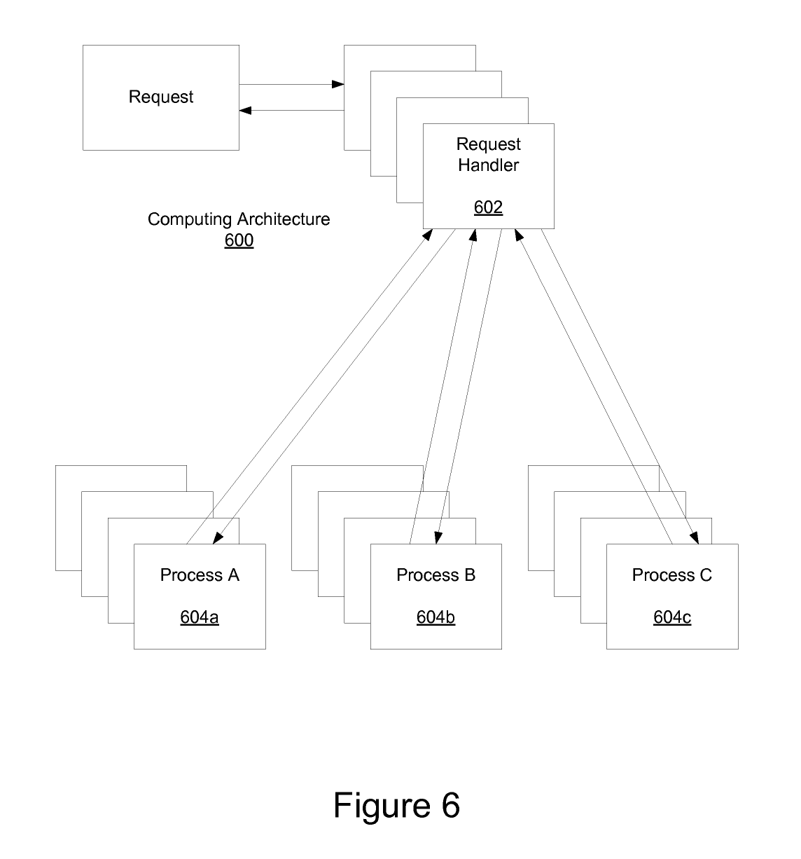

FIG. 6 shows a computing architecture in which the described embodiments can be implemented. In some embodiments, the prediction of the response of the consumer to targeted information is computed on a scalable computing architecture. In some embodiments, the scalable computing architecture includes swarm processing. The computer architecture of FIG. 6 can be particularly useful because it is a highly-scalable, parallel-processing architecture. The computing architecture 600 can be used for implementing the various functions previously described, such as behavioral data collection 132, behavioral data storage 142, clustering of behavioral data 152, clustered data storage 162, matching present user data with clustered behavioral data 232, and/or generating and targeting information 252.

In these embodiments, the computing architecture 600 comprises a request handler 602 and a multiple-processing framework and multiple concurrent processes 604 (604a, 604b, 604c), each such process representing a sub-task of a larger task that the architecture has been directed to complete. The computing architecture 600 can be implemented by a network of computers, such that the request handler 602 can assign any one or a multitude of the concurrent processes to any one or a multitude of networked computers (networked computers that can be communicated with by the computing architecture over available computer networks) for the completion of the task. Therefore, the overall capacity of the computing architecture to complete a task or a multitude of tasks within a certain elapsed time is only limited by the number of networked computers available. As the number of tasks grows, such as may occur by the addition of applications or visiting users, or the requirement for elapsed time to process a task decreases, or both, the computing architecture can successfully meet such requirements by adding additional networked computers, without limit.

For example, some embodiments include the simultaneous matching being handled by a request handler. The request handler receives multiple requests for matching and assigns any one or a multitude of the requests for matching to any one or a multitude of networked computers (networked computers that can be communicated with by the computing architecture over available computer networks) for the completion of the requests for matching. In some embodiments, clustering the collected behavioral data according to behavioral factors is handled by a request handler. The request handler receives multiple requests for clustering and assigns any one of a multitude of the requests for clustering to any one or a multitude of networked computers for the completion of the requests for clustering.

As a present user loads pages from the application that describe, for example, tennis rackets, contemporaneous to the load, a first server 132 executes the behavioral data collection of data describing the pages being loaded, while a second server 232 executes matching of present user data to one or more segments of clustered behavioral data. Some embodiments include the first and second servers employing the computing architecture 600 by accepting the task of matching the incoming data of the present user to segments in the Clustered Behavioral Data. In some embodiments, the task of matching is broken down into smaller sub-tasks that are assigned by the request handler 602 to various processes 604 (a, b, c). The request handler 602 subsequently assigns one or more processes 604 (a, b, c) to one or more networked computers. The assignment can be made for optimal speed of completion of each process 604. When all the processes 604 (a, b, c) are complete, the request handler 602 assembles the results of each sub-task from each corresponding processes 604 (a, b, c) into a complete result of the original task, namely that users who view tennis rackets are likely to buy tennis balls when offered a discount of a certain size.

In some embodiments, the request handler 602 includes Swarmiji, and the processes 604a, 604b, 604c include Sevaks. Only three Swarmiji Sevaks 604a, 604b, and 604c are shown for the purpose of illustration. Swarmiji Sevak is a Swarmiji worker process, and it can be easily spawned and coordinated to process real time or static data with a high degree of parallelism. Request handler 602 receives a request for a report or data from a requestor, such as a browser, a pricing engine, or a merchant. Thereafter, request handler 602 dispatches partial requests to Swarmiji Sevaks 604a, 604b, and 604c. Swarmiji Sevaks 604 a, 604b, and 604c complete partial requests and return the report to request handler 602. Request handler 602 then uses these reports to build a consolidated report and sends the report back to the requestor.

Swarmiji is a framework for creating and harnessing swarms of scalable concurrent processes called Swarmiji Sevaks. The framework is primarily written in Clojure on the Java Virtual Machine (JVM), which can utilize libraries from any JVM-compatible language. The framework draws heavily from existing systems such as Erlang, Termite, and the latest Nanite. The framework uses isolated processes to distribute computational load and pass messages to facilitate communication between processes. The framework also includes a management system that handles resource monitoring, process monitoring, etc.

Although specific embodiments have been described and illustrated, the embodiments are not to be limited to the specific forms or arrangements of parts so described and illustrated.

What is claimed is:

1. A computer-implemented method comprising:
compiling with a server coupled to a computer network behavioral data describing past actions including products viewed and purchases made by users while using applications hosted by servers accessible by computers of the users via the computer network;
segmenting with the server the behavioral data into clusters of behavior factors according to statistically related actions of the users;
compiling with the server present user data describing a current action of a user while using a merchant application hosted by the server coupled to the computer network and accessible by the user, the current action including the user adding a product to a virtual shopping cart of the merchant application;
while the user is still using the merchant application, performing with the server a comparative analysis including determining a match between the present user data and a cluster from the clusters of behavior factors and generating a demand function based on the match and the business rules associated with the merchant application;
generating with the server targeted information based on the comparative analysis, the targeted information including a discount for the product in the virtual shopping cart; and
providing by the server the targeted information including the discount for the product to the computer of the user for presentation before the user leaves the merchant application.

2. The computer-implemented method of claim 1, wherein
the present user data includes a second current action by the user adding one or more additional products to the virtual shopping cart,
generating the targeted information that includes the discount for the product in the virtual shopping cart further includes determining a coupon for the products in the virtual shopping cart based on the business rules associated with the merchant application, and
providing the targeted information includes providing the coupon for application to a total price of the product and the one or more additional products included in the virtual shopping cart.

3. The computer-implemented method of claim 1, wherein the business rules include one or more of a product group rule, a price group rule, and a product category group rule.

4. The computer-implemented method of claim 1, further comprising:
receiving wish list data describing one or more products saved by the user for a future purchase using corresponding interface elements of the merchant application;
storing the wish list data in a non-transitory storage device in association with the user; and
querying the wish list data and a product database to determine one or more corresponding products to the one or more products in the wish list data, wherein generating the targeted information further includes generating a recommendation for the one or more corresponding products and including the recommendation in the targeted information.

5. The computer-implemented method of claim 1, further comprising:
receiving by the server via the computer network a minimum advertised price (MAP) contract as one or more of the business rules, the MAP contract being between a merchant of the merchant application and a manufacturer of products offered for sale via the merchant application;
determining with the server a time and location for displaying the discount price to the user on the merchant application based on the MAP contract;
determining with the server a current time and location in association with the user's use of the merchant application;
determining a match between the current time and location and the time and location of the MAP contract; and
calculating the discount price for the product based on the match.

6. The computer-implemented method of claim 1, further comprising:
receiving from a computing device associated with a merchant of the merchant application, custom computer language including business terms and business logic expressing the business rules for the merchant application; and
storing the custom computer language as the business rules in a non-transitory storage device coupled to the server.

7. The computer-implemented method of claim 1, further comprising:
receiving with the server via the computer network sales velocity data describing sales velocity associated with the product, wherein the demand function is further generated based on the sales velocity and a corresponding sales velocity business rule stipulated by a merchant associated with the merchant application.

8. The computer-implemented method of claim 7, wherein the corresponding sales velocity business rule varies the discount applicable to the product based on whether the sales velocity is low or high.

9. A computer-implemented method comprising:
receiving business rules for an application hosted by the server coupled to a computer network and accessible by users;
compiling with the server present user data describing a current action of a user while using the application hosted by the server;
while the user is still using the application, computing with the server a match between the present user data and a precompiled cluster of behavior factors;
responsive to computing the match, generating with the server based on the match targeted information that includes information influenced based on business rules associated with the application; and
transmitting the targeted information to a computer of the user for presentation prior to the user leaving the application.

10. The computer-implemented method of claim 9, wherein the business rules include one or more of a product group rule, a price group rule, and a product category group rule.

11. The computer-implemented method of claim 9, where generating the targeted information further includes:
receiving by the server via the computer network a merchant determined rule including a range of business terms and conditional logic; and
applying by the server the business terms and conditional logic in combination to the targeted information.

12. The computer-implemented method of claim 9, further comprising:
influencing by the server via the computer network the targeted information based on a user specific list.

13. The computer-implemented method of claim 12, wherein the user specific list is a user wish list that includes one or more products desired by the user.

14. The computer-implemented method of claim 9, further comprising:
receiving by the server data describing a current action of a user while using the application, the current action including the user adding a product to a virtual shopping cart of the merchant application, wherein the targeted information includes a discount price for the product.

15. The computer-implemented method of claim 14, further comprising:
receiving by the server via the computer network a minimum advertised price (MAP) contract as one or more of the business rules, the MAP contract being between an administrator of the application and a manufacturer of products offered for sale via the application;
determining with the server a time and location for displaying the discount price to the user on the application based on the MAP contract;
determining with the server a current time and location in association with the user's use of the application;
determining a match between the current time and location and the time and location of the MAP contract; and
calculating the discount for the product based on the match.

16. The computer-implemented method of claim 14, further comprising:
receiving with the server via the computer network sales velocity data describing sales velocity associated with the product; and
influencing by the server via the computer network the targeted information based on the sales velocity.

17. The computer-implemented method of claim 9, further comprising:
estimating with the server real-time revenue increases and money earned by the application based on presenting the targeted information to the user; and
generating with the server a report showing sales data of the application while providing the targeted information to the user.

18. The computer-implemented method of claim 17, wherein the report includes product comparisons between one or more additional competitive merchants.

19. A system comprising:
one or more processors; and
one or more memories storing instructions that, when executed by the one or more processors cause the system to:
compile with a server coupled to a computer network behavioral data describing past actions including products viewed and purchases made by users while using applications hosted by servers accessible by computers of the users via the computer network;
segment with the server the behavioral data into clusters of behavior factors according to statistically related actions of the users;
compile with the server present user data describing a current action of a user while using a merchant application hosted by the server coupled to the computer network and accessible by the user, the current action including the user adding a product to a virtual shopping cart of the merchant application;
while the user is still using the merchant application, perform with the server a comparative analysis including determining a match between the present user data and a cluster from the clusters of behavior factors and generating a demand function based on the match and the business rules associated with the merchant application;
generate with the server targeted information based on the comparative analysis, the targeted information including a discount for the product in the virtual shopping cart; and
provide by the server the targeted information including the discount for the product to the computer of the user for presentation before the user leaves the merchant application.

20. The system of claim 19, wherein
the present user data includes a second current action by the user adding one or more additional products to the virtual shopping cart,
to generate the targeted information that includes the discount for the product in the virtual shopping cart further includes determining a coupon for the products in the virtual shopping cart based on the business rules associated with the merchant application, and
to provide the targeted information includes providing the coupon for application to a total price of the product and the one or more additional products included in the virtual shopping cart.

21. The system of claim 19, wherein the business rules include one or more of a product group rule, a price group rule, and a product category group rule.

22. The system of claim 19, wherein the instructions, when executed by the one or more processors, further cause the system to:
receiving wish list data describing one or more products saved by the user for a future purchase using corresponding interface elements of the merchant application;
storing the wish list data in a non-transitory storage device in association with the user; and
querying the wish list data and a product database to determine one or more corresponding products to the one or more products in the wish list data, wherein generating the targeted information further includes generating a recommendation for the one or more corresponding products and including the recommendation in the targeted information.

23. The system of claim 19, wherein the instructions, when executed by the one or more processors, further cause the system to:
receive by the server via the computer network a minimum advertised price (MAP) contract as one or more of the business rules, the MAP contract being between a merchant of the merchant application and a manufacturer of products offered for sale via the merchant application;
determine with the server a time and location for displaying the discount price to the user on the merchant application based on the MAP contract;
determine with the server a current time and location in association with the user's use of the merchant application;
determine a match between the current time and location and the time and location of the MAP contract; and
calculate the discount for the product based on the match.

24. The system of claim 19, wherein the instructions, when executed by the one or more processors, further cause the system to:
receive from a computing device associated with a merchant of the merchant application, custom computer language including business terms and business logic expressing the business rules for the merchant application; and
store the custom computer language as the business rules in a non-transitory storage device coupled to the server.

25. The system of claim 19, wherein the instructions, when executed by the one or more processors, further cause the system to:
receive with the server via the computer network sales velocity data describing sales velocity associated with the product, wherein the demand function is further generated based on the sales velocity and a corresponding sales velocity business rule stipulated by a merchant associated with the merchant application.

26. The system of claim 25, wherein the corresponding sales velocity business rule varies the discount applicable to the product based on whether the sales velocity is low or high.
